(19) United States
(12) Patent Application Publication
(10) Pub. No.: US 2010/0118139 A1
(43) Pub. Date: May 13, 2010

(54) Portable Device to Detect the Spin of Table Tennis Ball

(75) Inventors: Yuming Huang, Aurora, IL (US); Wanduan Huang, ZhengZhou (CN); Ailian Wang, ZhengZhou (CN); Yuzhu Huang, ZhengZhou (CN); Yuling Huang, ZhengZhou (CN); Yujian Huang, ZhengZhou (CN); Weihua Wang, Aurora, IL (US)

Correspondence Address: YUMING HUANG, 810 MEADOWRIDGE DRIVE, AURORA, IL, 60504, US

(73) Assignees: Yuming Huang, Aurora, IL (US); Weihua Wang, Aurora, IL (US); Yujian Huang, ZhengZhou (CN); Wanduan Huang, ZhengZhou (CN); Ailian Wang, ZhengZhou (CN); Yuzhu Huang, ZhengZhou (CN); Yuling Huang, ZhengZhou (CN)

(21) Appl. No.: 12/176,358

(22) Filed: Jul. 19, 2008

(51) Int. Cl. H04N 7/18

(52) U.S. Cl. 348/135; 340/815.45; 348/E07.085

(57) ABSTRACT

A portable device to detect the spin of table tennis ball is invented. The device helps a user to figure out the spin of a coming table tennis ball during a table tennis game. It is composed of a camera lens to acquire sequential images, an image processing chip to extract features of the table tennis ball and to calculate the direction and strength of the spin, and a mechanism to inform the user about the spin through certain methods.

One kind of the product design for the device, is to embed an integrated module into a pair of normal glasses. The integrated module consists of a mini camera lens, an image processing chip, a button battery and switch. The output of the module controls the LED lights located inside the frame of the glasses. For example of 8 points LED, the positions of 0, 3, 6, and 9 o'clock correspond to top spin, right spin, back spin, and left spin, respectively (refer FIG. 1 through FIG. 4). The centers of those position pairs correspond to top right spin, back right spin, back left spin, and top left spin respectively (refer FIG. 5 through FIG. 8). The brightness of the LED lights corresponds to the strength of the spin. Normal eyes perceive all the LED lights inside the frame, especially when they emit light.

A portable device to detect the spin of table tennis ball is invented. The device helps a user to figure out the spin of a coming table tennis ball during a table tennis game. It is composed of a camera lens to acquire sequential images, an image processing chip to extract features of the table tennis ball and to calculate the direction and strength of the spin, and a mechanism to inform the user about the spin through certain methods.

One kind of the product design for the device, is to embed an integrated module into a pair of normal glasses. The integrated module consists of a mini camera lens, an image processing chip, a button battery and switch. The output of the module controls the LED lights located inside the frame of the glasses. For example of 8 points LED, the positions of 0, 3, 6, and 9 o'clock correspond to top spin, right spin, back spin, and left spin, respectively (refer FIG. 1 through FIG. 4). The centers of those position pairs correspond to top right spin, back right spin, back left spin, and top left spin respectively (refer FIG. 5 through FIG. 8). The brightness of the LED lights corresponds to the strength of the spin. Normal eyes perceive all the LED lights inside the frame, especially when they emit light.

The portable device to detect the spin of table tennis ball is an integration of mature technology and products. The mini camera lens, image processor chip, button battery, LED lights have sizes as small as millimeters and weights as light as grams. The time for image acquisition, processing and signal display is in the scale of milliseconds. Although the whole device can be built into a pair of glasses, products of the portable device to detect the spin of table tennis ball, could assume different forms other than glasses.

Glasses with one or more built-in cameras exist on market now. The resolution of the mini camera lens on a cell phone, can be as high as 5˜10 million pixels. The speed of the electronic switch of CCD sensor (or the read write speed of pixel array), reaches 1000 frames per second or higher. The storage of huge amount of sequential image data is not necessary, since the spin calculation is based on the latest two (or a few) neighboring images. To extract the shape and feature of a table tennis ball, the followings can be used: the obvious different color of the table tennis ball from its background (regulated by ITTF—International Table Tennis Federation), the trademark and spots on the table tennis ball, etc. The direction and speed of the ball spin is calculated based on the displacement of the ball features of timely neighboring images. The image area occupied by the ball helps to determine the distance between the ball and the camera lens. The linear speed of the ball traveling across the table and the recognition of a coming ball or a departing ball can be done too. There are references regarding the spin detection of different balls (table tennis ball, tennis ball, soccer ball etc.). The equipments that implement the functionality are big and not portable in any means.

The definition of the spin direction of a table tennis ball is in accordance with the sensation of a table tennis player. It is not defined in the reference system of the table tennis ball itself. Actually, the two definitions are just opposite with each other, due to the action and anti-action between the table tennis ball and the table tennis paddle.

Since the table tennis ball is always at the center of players' visual attention, if the camera lens is located in a suitable place (for example, embedded in a pair of glasses) and has a suitable focus length, the ball appears in each image and occupies enough amount of pixels.

According to research, for the standard 40 millimeter ball played by top professional players, the fastest linear speed (across table) is 17 meters per second, the highest spin speed is 120 cycles per second for loop (75 cycles per second for serve). According to Nyquist Sampling Theorem, a camera of 300 frames per second is capable to detect spin speed of 150 cycles per second or lower, which exists in the market. Normal TV or cell phone cameras have 24 to 30 image frames per second, which can be used for non-professional players, as low end products.

The time consumed by image acquisition, processing, and LED emitting light is less than 10 millisecond. The maximum distance traveled by the ball during the period is less than 20 meter/second*0.01 second=0.2 meter which is less than 1/10 of the whole table (2.74 meter). On the other hand, the temporary stay of human vision (visual inert) is 100 to 500 millisecond. Therefore, the ball spin detection device is able to inform its user about the ball spin in real time.

It's possible that the future table tennis ball to have texture on its surface, since textured ball is easier for player to see its spin. Audiences are easier to see clear a texture ball than a uniform colored ball, too. In the past, in order to achieve the above effects, ITTF (International Table Tennis Federation) made many reforms to its regulation: to change ball color from white to orange, to change ball size from 38 millimeter to 40 millimeter. The textured ball helps machine to detect its spin.

Depending on the condition of a user, the glasses of the spin detection device may have no lenses, have lenses without vision correction, or have correction lenses already used by the user. The light weight and small size of the whole device make it no different from a normal pair of glasses.

The number of LED lights determines the representation accuracy of the spin direction of a table tennis ball. There is no technical issue regarding more than 8 LED lights (16, 32, . . . or linear LED lights) on a glass frame. However, the spin direction accuracy (top spin, right spin, back spin, and left spin, top right spin, back right spin, back left spin, and top left spin) is enough for table tennis players. There may be products that have more accurate indication of spin direction.

There is no ball spin direction indication (By LED lights, for example) if the visual field of the spin detection device contains no ball or more than one balls. Users may turn off the spin indication of departing balls and pay attention only to the spin of coming balls.

### SPECIFICATION

A portable device to detect the spin of table tennis ball is invented. The device helps a user to figure out the spin of a coming table tennis ball during a table tennis game. It is composed of a camera lens to acquire sequential images, an image processing chip to extract features of the table tennis ball and to calculate the direction and strength of the spin, and a mechanism to inform the user about the spin through certain methods.

One kind of the product design for the device, is to embed an integrated module into a pair of normal glasses. The integrated module consists of a mini camera lens, an image processing chip, a button battery and switch. The output of the module controls the LED lights located inside the frame of the glasses. For example of 8 points LED, the positions of 0, 3, 6, and 9 o'clock correspond to top spin, right spin, back spin, and left spin, respectively (refer FIG. 1 through FIG. 4). The centers of those position pairs correspond to top right spin, back right spin, back left spin, and top left spin respectively (refer FIG. 5 through FIG. 8). The brightness of the LED lights corresponds to the strength of the spin. Normal eyes perceive all the LED lights inside the frame, especially when they emit light.

The portable device to detect the spin of table tennis ball is an integration of mature technology and products. The mini camera lens, image processor chip, button battery, LED lights have sizes as small as millimeters and weights as light as grams. The time for image acquisition, processing and signal display is in the scale of milliseconds. Although the whole device can be built into a pair of glasses, products of the portable device to detect the spin of table tennis ball, could assume different forms other than glasses.

Glasses with one or more built-in cameras exist on market now. The resolution of the mini camera lens on a cell phone, can be as high as 5˜10 million pixels. The speed of the electronic switch of CCD sensor (or the read write speed of pixel array), reaches 1000 frames per second or higher. The storage of huge amount of sequential image data is not necessary, since the spin calculation is based on the latest two (or a few) neighboring images. To extract the shape and feature of a table tennis ball, the followings can be used: the obvious different color of the table tennis ball from its background (regulated by ITTF—International Table Tennis Federation), the trademark and spots on the table tennis ball, etc. The direction and speed of the ball spin is calculated based on the displacement of the ball features of timely neighboring images. The image area occupied by the ball helps to determine the distance between the ball and the camera lens. The linear speed of the ball traveling across the table and the recognition of a coming ball or a departing ball can be done too. There are references regarding the spin detection of different balls (table tennis ball, tennis ball, soccer ball etc.). The equipments that implement the functionality are big and not portable in any means.

The definition of the spin direction of a table tennis ball is in accordance with the sensation of a table tennis player. It is not defined in the reference system of the table tennis ball itself. Actually, the two definitions are just opposite with each other, due to the action and anti-action between the table tennis ball and the table tennis paddle.

Since the table tennis ball is always at the center of players' visual attention, if the camera lens is located in a suitable place (for example, embedded in a pair of glasses) and has a suitable focus length, the ball appears in each image and occupies enough amount of pixels.

According to research, for the standard 40 millimeter ball played by top professional players, the fastest linear speed (across table) is 17 meters per second, the highest spin speed is 120 cycles per second for loop (75 cycles per second for serve). According to Nyquist Sampling Theorem, a camera of 300 frames per second is capable to detect spin speed of 150 cycles per second or lower, which exists in the market. Normal TV or cell phone cameras have 24 to 30 image frames per second, which can be used for non-professional players, as low end products.

The time consumed by image acquisition, processing, and LED emitting light is less than 10 millisecond. The maximum distance traveled by the ball during the period is less than 20 meter/second*0.01 second=0.2 meter which is less than 1/10 of the whole table (2.74 meter). On the other hand, the temporary stay of human vision (visual inert) is 100 to 500 millisecond. Therefore, the ball spin detection device is able to inform its user about the ball spin in real time.

It's possible that the future table tennis ball to have texture on its surface, since textured ball is easier for player to see its spin. Audiences are easier to see clear a texture ball than a uniform colored ball, too. In the past, in order to achieve the above effects, ITTF (International Table Tennis Federation) made many reforms to its regulation: to change ball color from white to orange, to change ball size from 38 millimeter to 40 millimeter. The textured ball helps machine to detect its spin.

Depending on the condition of a user, the glasses of the spin detection device may have no lenses, have lenses without vision correction, or have correction lenses already used by the user. The light weight and small size of the whole device make it no different from a normal pair of glasses.

The number of LED lights determines the representation accuracy of the spin direction of a table tennis ball. There is no technical issue regarding more than 8 LED lights (16, 32, . . . or linear LED lights) on a glass frame. However, the spin direction accuracy (top spin, right spin, back spin, and left spin, top right spin, back right spin, back left spin, and top left spin) is enough for table tennis players. There may be products that have more accurate indication of spin direction.

There is no ball spin direction indication (By LED lights, for example) if the visual field of the spin detection device contains no ball or more than one balls. Users may turn off the spin indication of departing balls and pay attention only to the spin of coming balls.

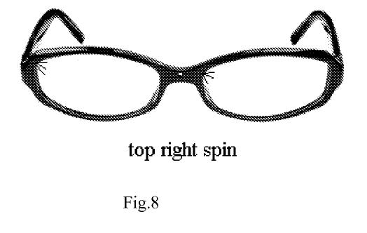

FIG. 1˜FIG. 8 show which LED lights are on when different ball spin is detected by the device. The device user knows spin via LED lighting. Normally, other people are unable to perceive the LED lighting.

FIG. 1 shows LED lighting when ball back spin is detected.

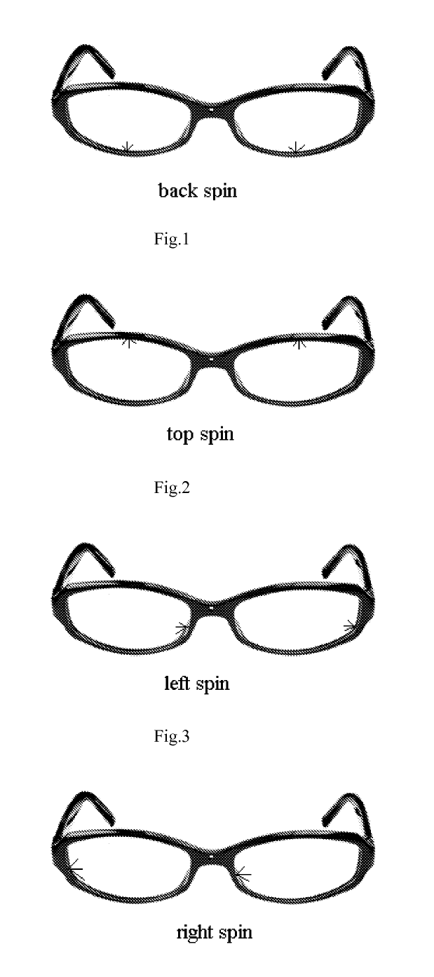

FIG. 2 shows LED lighting when ball top spin is detected.

FIG. 3 shows LED lighting when ball left spin is detected.

FIG. 4 shows LED lighting when ball right spin is detected.

FIG. 5 shows LED lighting when ball back left spin is detected.

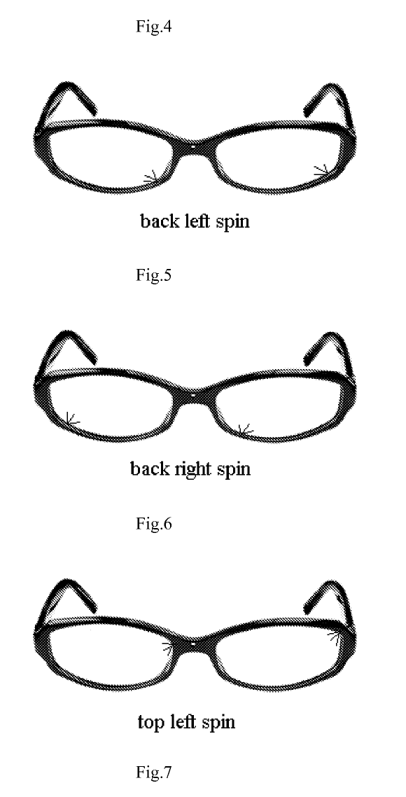

FIG. 6 shows LED lighting when ball back right spin is detected.

FIG. 7 shows LED lighting when ball top left spin is detected.

FIG. 8 shows LED lighting when ball top right spin is detected.

1. A portable device to detect the spin of a table tennis ball is invented. The device collects images of a table tennis ball, processes the images to calculate the direction and speed of the ball's spin. The device informs its user about the spin parameters.

2. The portable device in claim 1, is a pair of glasses with built-in mini camera lens, image processor chip, button battery, switch, and LED lights, etc.

3. The portable device in claim 1, is a pair of glasses with some of following components built into it: mini camera lens, image processor chip, button battery, switch, and LED lights, etc. Other components are located elsewhere.

4. The portable device in claim 1, is in the form other than a pair of glasses.

5. The portable device in claim 1, have one or multiple cameras.

6. The portable device in claim 1, informs its user about ball spin via LED lights.

7. The portable device in claim 1, informs its user about ball spin through the method other than LED lights, say voice.

8. The glasses in claims 2 and 3, may have lenses or not have lenses. The lenses may have or not have visual correction functionalities.

9. The number of LED lights in claims 2, 3 and 6, can be any number: 8, more than 8, or less than 8.

10. A portable device carried by a table tennis player, informs its user about table tennis ball with the help from other devices which could be large and not carried by the user. The portable device carried by the player could be a pair of glasses, an ear plug, etc. Certain communications exists between the device carried by the player and the devices not carried by the player.

11. A portable device carried by a player to detect the spin of ball shaped objects (tennis ball, soccer ball, etc.) other than table tennis ball. The device carried by the player may get help from other devices not carried by the player.
